(19) United States
(12) Patent Application Publication
(10) Pub. No.: US 2026/0316703 A1
(43) Pub. Date: Oct. 15, 2026

(54) DEVICE AND METHOD FOR STABILISING AN ON_BOARD ELECTRICAL SYSTEM OF A VEHICLE

(71) Applicant: SCHAEFFLER TECHNOLOGIES AG & CO. KG, Herzogenaurach (DE)

(72) Inventors: Fadi Rifai, Regensburg (DE); Rainer Knorr, Regensburg (DE)

(73) Assignee: SCHAEFFLER TECHNOLOGIES AG & CO. KG, Herzogenaurach (DE)

(21) Appl. No.: 19/483,149

(22) PCT Filed: Apr. 26, 2024
(86) PCT No.: PCT/EP2024/061537

§ 371 Date: Nov. 10, 2025

(30) Foreign Application Priority Data
May 11, 2023 (DE) DE102023204347.5

(51) Int. Cl. B60R 16/03; H02J 7/00; H02J 7/34; H02J 7/80; H02J 7/96

(52) U.S. Cl. CPC B60R 16/03; H02J 7/345; H02J 7/80; H02J 7/855; H02J 7/96; H02J 2207/20; H02J 2207/50

(57) ABSTRACT

A device for stabilizing an on-board power supply voltage in an on-board power supply of a vehicle has a first energy storage unit, a bidirectional DC/DC converter, a series circuit and an on-board power supply connection for connecting to the on-board power supply. The series circuit includes a current measuring arrangement and a buffer capacitor. The bidirectional DC/DC converter is connected to the first energy storage unit by a first DC/DC connection and is connected to the on-board power supply connection by a second DC/DC connection. The current measuring arrangement is designed to provide a first measurement signal, which is representative of a current that is flowing in the series circuit, for a control unit. The DC/DC converter is designed to operate in a buck mode or a boost mode on the basis of a control signal that the control unit provides depending on the first measurement signal.

### CROSS REFERENCE TO RELATED APPLICATIONS

This application is the U.S. National Phase Application of PCT International Application No. PCT/EP2024/061537, filed Apr. 26, 2024, which claims priority to German Patent Application No. 10 2023 204 347.5, filed May 11, 2023, the contents of such applications being incorporated by reference herein.

### FIELD OF THE INVENTION

The invention relates to a device for stabilizing an on-board power supply, in particular a low-voltage on-board power supply, of a vehicle. The invention also relates to a method and to a corresponding control unit for stabilizing an on-board power supply, in particular a low-voltage on-board power supply, of a vehicle. The invention furthermore relates to an on-board power supply system, to a computer program and to a computer program product.

### BACKGROUND OF THE INVENTION

On-board power supplies are provided in motor vehicles to operate electrical consumers. Some types of consumers are particularly sensitive to voltage dips or voltage spikes in the supply voltage, for example, on-board power supply electronics or even the lighting. If such sensitive consumers are subjected to a voltage dip or a voltage spike, their function may then be at least partially impaired. In this case, the operation of the vehicle may be impaired and/or there may be undesirable side effects, such as momentary darkening of the lighting of the motor vehicle.

It is also known practice to use rechargeable batteries with low internal resistance and high electrical power to absorb voltage spikes or voltage dips. However, significant voltage dips arise particularly in the case of high, abrupt loadings despite high capacities and powers (and despite a high space requirement associated therewith and high weight).

Furthermore, particularly in modern vehicles, dynamic electrical consumers are present, the operation of which may cause a severe voltage dip, for instance a starter motor of a start/stop module or an anti-lock braking system or a drive of an electrical steering system, such as are used in parking assistants. In particular, these dynamic consumers are also activated during the operation of the vehicle and not only upon the initial cold start or when parking the vehicle.

In order to absorb voltage spikes or voltage dips and to avoid adverse effects on the load behavior, a plurality of rechargeable batteries, for example lead rechargeable batteries, are currently distributed in the on-board power supply. These batteries may be used to absorb the voltage spikes or voltage dips to a limited extent. However, the batteries react too slowly for very dynamic consumers. In addition, the rechargeable batteries have a high weight. An alternative solution is the use of electrochemical capacitors, which are also referred to as supercapacitors or ultracapacitors. In this case, a plurality of electrochemical capacitors that are connected in series are used instead of the rechargeable battery. The electrochemical capacitors allow a faster reaction time in comparison to the rechargeable batteries. However, if the capacitor arrangement has to provide energy, the capacitor voltage may decrease relatively quickly and fall below a minimum supply voltage for some consumers.

An aspect of the invention is based are a device and a method for stabilizing an on-board power supply of a vehicle, said device or method allowing voltage spikes or voltage dips in the on-board power supply to be compensated for more quickly and/or with lower supply voltage fluctuations for consumers of the on-board power supply.

According to a first aspect, the problem is solved by a device for stabilizing an on-board power supply voltage in an on-board power supply of a vehicle. The device has a first energy storage unit and a bidirectional DC/DC converter. The bidirectional DC/DC converter has a first DC/DC connection and a second DC/DC connection. The first DC/DC connection is connected to the first energy storage unit. The second DC/DC connection of the DC/DC converter is able to be connected to the on-board power supply via an on-board power supply connection.

The device also comprises a series circuit. The series circuit has a current measuring arrangement and a buffer capacitor that are connected in series.

A first connection of the series circuit is connected to the on-board power supply connection, which is provided for connecting the device to the on-board power supply, and a second connection of the series circuit is connected to a reference potential. The current measuring arrangement is designed to provide a first measurement signal, which is representative of a current that is flowing in the series circuit, for a control unit.

The DC/DC converter is designed to operate in a buck mode or in a boost mode on the basis of a control signal that the control unit provides depending on the first measurement signal.

The control signal may comprise a control command.

Preferably, the energy storage unit has a first supply connection and a second supply connection and the first supply connection is connected to the first DC/DC connection. The second supply connection of the energy storage unit is connected to a reference potential, in particular ground.

The device may comprise the control unit or the control unit may be assigned to the device. The control unit is in particular designed to ascertain the control signal on the basis of the first measurement signal and to then provide the control signal for the DC/DC converter.

The evaluation of the current that is flowing into or out of the buffer capacitor allows a better stabilization of the on-board power supply and a fast reaction time by predicting the required operation (buck or boost). It takes a certain amount of time to switch from buck mode to boost mode and vice versa. The current measurement and the analysis of the current gradient allows very early detection as to whether the DC/DC converter has to provide a boost converter function or a buck converter function and the DC/DC converter is able to be accordingly actuated at an early stage.

Furthermore, evaluating the current that is flowing into or out of the buffer capacitor makes it possible to increase the effectiveness of the voltage stabilization, since the threshold values for detecting the overvoltage and the undervoltage may be chosen to be closer. A pure voltage threshold detection for the overvoltages and undervoltage has the disadvantage that, if the voltage thresholds are set to be very close (owing to early detection), the DC/DC converter changes the operating mode very often and the effectiveness of the voltage support decreases.

If, on the other hand, the voltage thresholds are set to be far apart from one another, this may lead to the changeover taking effect too late on account of the time it takes to switch from buck mode to boost mode and vice versa, and it is no longer possible to prevent a voltage dip.

Furthermore, undesired additional oscillations of the voltage supply that is to be supported are able to be prevented or at least reduced by means of the evaluation of the current that is flowing into or out of the buffer capacitor. If the oscillations of the supply voltage have a faster speed or a similar speed to the switching of the operating modes of the DC/DC converter on account of the inductances of the supply lines to the load and the energy storage unit of the on-board power supply, then this will lead to additional oscillations in the voltage supply that is to be supported.

In at least one configuration according to the first aspect, the device has a voltage measuring arrangement that is designed and arranged to provide a second measurement signal, which is representative of a voltage at the on-board power supply connection, in particular of a voltage that is present between the on-board power supply connection and the reference potential or a further reference potential.

In at least one configuration according to the first aspect, the voltage measuring arrangement has a voltage divider with a partial voltage tap, which is connected to the control unit for providing the second measurement signal.

In at least one configuration according to the first aspect, the control unit is designed to additionally ascertain the control signal that it provides for the DC/DC converter on the basis of the second measurement signal.

In at least one configuration according to the first aspect, the energy storage unit has at least one electrochemical capacitor, which is also referred to as a supercapacitor or an ultracapacitor. In particular, a plurality of ultracapacitors in series are used instead of an additional battery, as their current rate of rise is better than that of lead batteries, for example.

According to a second and a third aspect, a method and a corresponding control unit for operating a device according to the first aspect and for stabilizing an on-board power supply voltage in an on-board power supply of a vehicle are disclosed. In this case, first measurement data that are representative of a current that is flowing in the series circuit are read in. Preferably, the first measurement signal is captured by the current sensor of the device and the control unit ascertains current values in predetermined time steps on the basis of the first measurement data. At least some of the current values may be buffer-stored for a predetermined period of time.

In a further step, a temporal current gradient is ascertained on the basis of the first measurement data. The current gradient may be ascertained in particular on the basis of a present current value and a previously ascertained current value, which has been ascertained, for example, one time step earlier.

The ascertained current gradient is then compared with a predetermined gradient threshold value and, if the absolute value of the ascertained current gradient exceeds the predetermined gradient threshold value, the control signal is ascertained and provided for the DC/DC converter on the basis of the first measurement data and/or the ascertained current gradient, wherein the control signal causes the DC/DC converter to operate in boost mode or buck mode.

The control unit may have a processor that is configured so as to carry out the method according to the second aspect.

Alternatively, the control unit may comprise a receiving module, a computing module and an output module. In this case, the receiving module may be designed to receive the first measurement signal and to carry out an analog-to-digital conversion of the first measurement signal and therefore to read in the first measurement data. The computing module may be designed to ascertain the temporal current gradient on the basis of the first measurement data, to compare the ascertained current gradient with the predetermined gradient threshold value and, if the absolute value of the ascertained current gradient exceeds the predetermined gradient threshold value, to ascertain the control signal for the DC/DC converter on the basis of the first measurement data and/or the ascertained current gradient. The output module may be designed to transmit the control signal ascertained by the computing unit to the DC/DC converter.

In at least one advantageous configuration according to the second and the third aspect, the control signal is additionally ascertained on the basis of provided second measurement data, wherein, before the control signal is provided, the method has the further steps of:
reading in the provided second measurement data that are representative of a voltage that is present at the on-board power supply connection, and ascertaining a voltage value on the basis of the second measurement data,
if a current is flowing from the capacitor into the on-board power supply, checking whether the ascertained voltage value falls below a lower voltage limit value, and if the ascertained voltage value falls below the lower voltage limit value, providing the control signal in such a way that the control signal causes the DC/DC converter to operate in boost mode, and
if the current is flowing from the on-board power supply into the capacitor, checking whether the ascertained voltage value exceeds an upper voltage limit value, and if the ascertained voltage value falls below the lower voltage limit value, providing the control signal in such a way that the control signal causes the DC/DC converter to operate in buck mode.

A current direction, i.e. whether the current is flowing from the capacitor into the on-board power supply or from the on-board power supply into the capacitor, may be ascertained by means of the current values. In particular, a direction of the current may be determined on the basis of an arithmetic sign of the current values.

In at least one advantageous configuration according to the second and the third aspect, a current that the DC/DC converter provides at the second DC/DC connection in boost mode or buck mode is regulated by means of a controller on the basis of the first measurement data.

The control unit may have a controller, for example a controller with proportional, integral and differential behavior (PID controller). The controller may be in the form of a software module or a hardware module, or a hybrid software/hardware module. In this case, the controller uses the first measurement data as a control variable. The control unit ascertains the buck converter current that is to be set by the DC/DC converter or the boost converter current in such a way that the current of the buffer capacitor is regulated to zero.

Advantageous configurations of the first aspect also apply in this case to the second and the third aspect.

According to a fourth aspect, an on-board power supply system for a vehicle with a device according to the first aspect, an on-board power supply and a control unit according to the third aspect are disclosed. The on-board power supply is connected to the on-board power supply connection of the device. Preferably, the control unit is connected to the first measuring arrangement to receive the first measurement signal and to the second measuring arrangement to receive the second measurement signal and to the control input of the DC/DC converter.

According to a fifth aspect, a computer program comprising instructions which, when the program is executed by a control computer, cause the latter to carry out the method according to the second aspect is disclosed.

Within the meaning of this document, the designation of such a computer program is synonymous with the concept of a program element and/or a software module and/or a computer program product that contains instructions for controlling the control computer in order to coordinate the operation of the system or the method in a suitable manner in order to achieve the effects linked to the method according to an aspect of the invention. The computer program may be implemented as computer-readable instruction code in any suitable programming language, such as in JAVA, C++, etc.

The control computer has a processor and a program memory. Alternatively, the program memory may be assigned to the control computer. The processor may have a central processing unit (CPU). The processor may be an all-purpose processor, a microprocessor, a microcontroller, a digital signal processor (DSP), an application-specific integrated circuit (ASIC), a field-programmable gate array (FPGA), or another programmable logic device, a discrete gate logic device or transistor logic device, a discrete hardware component, or the like.

According to a sixth aspect, a computer-readable medium that includes instructions, which, when executed by a control computer, cause the control computer to carry out the method according to the second aspect is disclosed.

The computer program may be stored on a computer-readable storage medium (CD-ROM, DVD, Blu-ray disk, removable drive, volatile or non-volatile memory, in particular random access memory (RAM), read-only memory (ROM), erasable programmable read-only memory (EPROM), and/or flash memory. The storage medium may be a memory built into the processor, a memory arranged outside the processor on an assembly, or a portable memory. The memory is configured to store associated program instructions and associated data.

Furthermore, the computer program may be provided in a network such as the Internet, from which a user is able to download it as required.

Advantageous configurations of the first, the second and the third aspect also apply in this case to the fourth, the fifth and the sixth aspect.

Exemplary embodiments of the invention are explained below on the basis of the schematic drawings. The description of the subject matter specified here is not limited to the individual special embodiments. Features of different exemplary embodiments may-as far as technically reasonable-be combined with one another in order to form further exemplary embodiments. For example, variations or modifications described with respect to one of the exemplary embodiments may also be applicable to other exemplary embodiments, unless indicated otherwise.

### BRIEF DESCRIPTION OF THE DRAWINGS

FIG. 1 shows an exemplary block diagram of an exemplary embodiment for an on-board power supply system, and

FIG. 2 shows an exemplary flowchart for a program for operating a device for stabilizing an on-board power supply of a vehicle.

In the figures, the same reference signs are used for elements with essentially the same function, but these elements do not have to be identical in all details.

### DETAILED DESCRIPTION OF EXEMPLARY EMBODIMENTS

It is pointed out that, if an element is referred to as being “connected” or “coupled” to another element, the element may be connected or coupled directly to the other element or intermediate elements may be present. In contrast, if an element is referred to as being “connected” or “coupled” “directly” to another element, there are no intermediate elements present. Other expressions used to describe the relationship between elements should be interpreted in the same way (e.g. “between” versus “directly between”, “adjacent” versus “directly adjacent”, etc.).

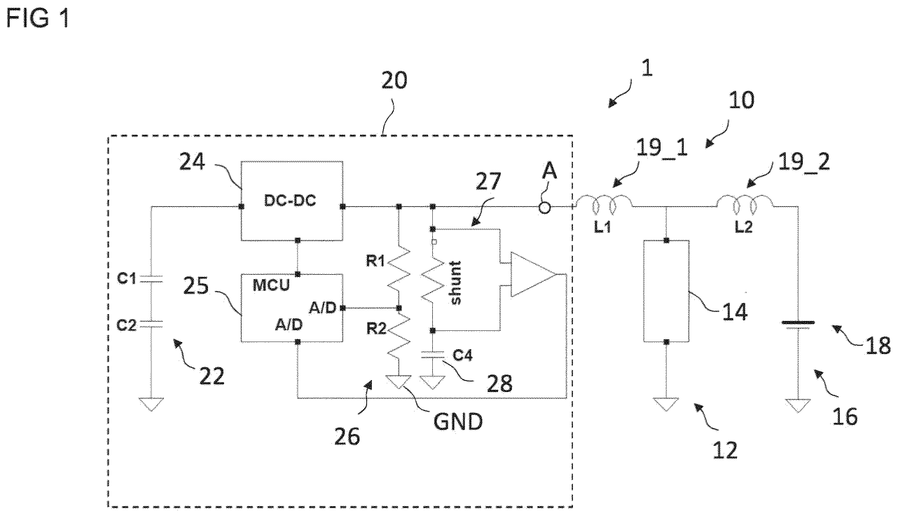

FIG. 1 shows a block circuit diagram of an exemplary on-board power supply system 1 of a vehicle. The on-board power supply system 1 has an on-board power supply 10. The on-board power supply 10 is preferably a low-voltage on-board power supply, for example a 12 V on-board power supply, of the vehicle. It should be noted here that a typical car on-board power supply 12 V battery, which is charged via the on-board power supply when the generator (not shown in FIG. 1) is running, has an actual voltage of up to 14.4 V.

The on-board power supply 10 has at least one load branch 12 and at least one supply branch 16 arranged in parallel with the load branch 12. One or more consumers 14 may be arranged in the load branch 12. The supply branch 16 has a main energy storage unit 18. By way of example, the main energy storage unit 18 is a low-voltage rechargeable battery. By way of example, the low-voltage rechargeable battery has a nominal voltage of 12 volts. Alternatively, the low-voltage rechargeable battery may have a nominal voltage of, for example, 24 volts, 48 volts or another typical low voltage of a low-voltage network.

The on-board power supply system 1 also has a device 20 for stabilizing an on-board power supply voltage of the on-board power supply 10. The device 20 has an on-board power supply connection A, which is connected to the on-board power supply 10.

The device 20 has a first energy storage unit 22, a bidirectional DC/DC converter 24, a voltage measuring arrangement 26 and a current measuring arrangement 27, and a buffer capacitor 28.

The first energy storage unit 22 preferably comprises one or more electrochemical capacitors C1, C2 that are connected in series and are also referred to as supercapacitors or ultracapacitors. When using a supercapacitor arrangement as the first energy storage unit 22, this preferably has a capacitance of 100 μF to 500 μF.

Alternatively or additionally, the first energy storage unit 22 may have a rechargeable battery, for example a lithium-ion rechargeable battery. Alternatively, the first energy storage unit 22 may have a lithium-iron phosphate rechargeable battery or a nickel-metal hydride rechargeable battery.

The bidirectional DC/DC converter 24 has a first DC/DC connection, a second DC/DC connection and a control connection. The DC/DC converter 24 is connected directly or indirectly to a first supply connection of the first energy storage unit 22 by way of the first DC/DC connection. The second connection of the DC/DC converter is connected directly or indirectly to the on-board power supply 10. The control input of the DC/DC converter 24 is connected to a control unit 25. The device 20 may comprise the control unit 25. Alternatively, the control unit 25 may be assigned to the device 20.

The arrangement makes it possible to drain current from the on-board power supply 10 via the DC/DC converter 24 in the event of a high voltage level or in the event of an energy surplus (or in the event of a high state of charge) in the on-board power supply 10. Current may also flow in the reverse direction if the on-board power supply 10 has a low voltage level. A high voltage level refers to a voltage that is above a predetermined upper limit. A low voltage level refers to a voltage that is below a predetermined lower limit.

The current measuring arrangement 27 and the buffer capacitor 28 are connected in series. This series circuit is arranged in a branch that is arranged in parallel with the load branch 12 and the supply branch 16 of the on-board power supply 10.

The current measuring arrangement 27 is designed to provide a first measurement signal, which is representative of a current that is flowing into the buffer capacitor 28 or out of the buffer capacitor 28. By way of example, the current measuring arrangement has a shunt resistor.

The voltage measuring arrangement 26 is designed and arranged to provide a second measurement signal, which is representative of a voltage at the on-board power supply connection A, for the control unit 25. The second measurement signal therefore represents the sum of the voltage that is dropped across the load branch 12 and the voltage that is dropped along the supply line to the load branch 12 on account of line inductances 19_1, 19_2.

By way of example, the voltage measuring arrangement 26 has a voltage divider that is arranged in parallel with the load branch 12 or the supply branch 16 of the on-board power supply 10. The voltage divider has a first connection, a second connection and a partial voltage tap. By way of example, the voltage divider is connected, by way of its first connection, to the second connection of the DC/DC converter and, by way of its second connection, to a reference potential, for example ground. By way of example, the partial voltage tap is connected to the control unit 25, in particular to an analog/digital converter of the control unit 25.

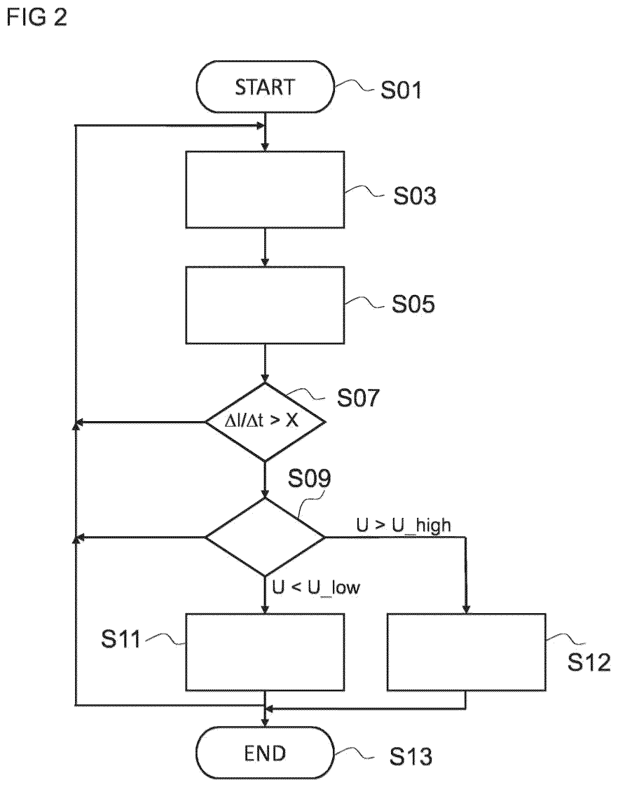

FIG. 2 shows an exemplary flowchart for a program for operating the device 20 for stabilizing the on-board power supply 10. By way of example, the program is executed by a control computer of the device. By way of example, the control computer has a microcontroller or a microprocessor and a program memory. The microcontroller and/or microprocessor may have one or more integrated analog/digital converters. The control computer may be part of the control unit or may be the control unit.

The program is started in a step S01. By way of example, variables are initialized in step S01.

In a step S03, first measurement data, which are provided, for example, by a further analog/digital converter of the control unit 25, are read in. The first measurement data are representative of a current that is flowing into or out of the buffer capacitor 28. A temporal current gradient is also ascertained in step S03 on the basis of a previously ascertained current value and the presently ascertained current value.

In a step S05, second measurement data, which are provided, for example, by a further analog/digital converter of the control unit 25, are read in. The second measurement data are representative of a voltage in the on-board power supply 10, in particular for a voltage that is present at the on-board power supply connection A (with respect to the reference potential GND). In step S05, a voltage value is also ascertained on the basis of the first measurement data.

Steps S03 and S05 may be executed simultaneously or sequentially, or else in reverse order.

In a step S07, the ascertained current gradient is compared with a predetermined gradient threshold value of, for example, 50 A/ms. If the ascertained current gradient exceeds the predetermined threshold value, a check is carried out in a step S09 to determine whether the ascertained voltage value falls below a lower voltage limit value or exceeds an upper voltage limit value.

If the ascertained voltage value falls below the lower voltage limit value, of, for example, 13.5 V, in a step S11, a first current to be provided by the DC/DC converter 24 for the on-board power supply 10 is ascertained on the basis of the current gradient and/or the presently ascertained current value. In step S11, a first actuation signal for the DC/DC converter 24 is also provided, which causes the DC/DC converter 24 to operate in a boost mode and to provide the first ascertained current.

If the ascertained voltage value exceeds the upper voltage limit value, of, for example, 15 V, in a step S13, a second current to be provided by the DC/DC converter 24 for the on-board power supply 10 is ascertained on the basis of the current gradient and/or the presently ascertained current value. In step S12, a second actuation signal for the DC/DC converter 24 is also provided, which causes the DC/DC converter 24 to operate in a buck mode and to provide the second ascertained current.

To this end, the control unit may have a PID controller. The PID controller may be in the form of a software module or a hardware module, or a hybrid software and hardware module. The input variable of the PID controller is the current, which is in each case ascertained from the first measurement data, that is flowing into the buffer capacitor 28. The PID controller controls the DC/DC converter 24 in such a way that the DC/DC converter 24 provides a boost current or a buck current, with the result that the output current or the input current of the buffer capacitor 28 is regulated to zero. By way of example, the PID controller is deactivated as soon as the lower voltage limit value plus a hysteresis value of, for example, 0.25 V is exceeded or as soon as the upper voltage limit value minus a hysteresis value of, for example, 0.25 V is exceeded.

In a step S13, the program is ended. It is advantageous for the first and second measurement data to be continuously captured and evaluated during the operation of the vehicle.

By virtue of the current measuring arrangement 27 being arranged in the same branch as the buffer capacitor 28, a current change caused by an overvoltage or an undervoltage is able to be identified very quickly and at an early stage, and the DC/DC converter is able to be suitably actuated.

Evaluating the current change has the advantage that the hysteresis for the voltage evaluation may be very narrow, and therefore the DC/DC converter may be suitably actuated very quickly and at an early stage, i.e. the correct mode and the current that has to be provided by the DC/DC converter may be set.

It should be noted that embodiments of the invention have been described with reference to different subject matter of the invention. In particular, some embodiments of the invention are described by way of method claims and other embodiments of the invention are described by way of device claims. However, it will become immediately clear to a person skilled in the art on reading this application that, unless explicitly stated otherwise, in addition to a combination of features that are associated with one type of subject matter of the invention, any combination of features that are associated with different types of subject matter of the invention is also possible.

1. A device for stabilizing an on-board power supply voltage in an on-board power supply of a vehicle, wherein
the device has a first energy storage unit, a bidirectional DC/DC converter, a series circuit and an on-board power supply connection for connecting to the on-board power supply,
the series circuit has a current measuring arrangement and a buffer capacitor that are connected in series,
the bidirectional DC/DC converter has a first DC/DC connection, a second DC/DC connection and a control connection, and the bidirectional DC/DC converter is connected to the first energy storage unit by way of the first DC/DC connection and is connected to the on-board power supply connection by way of the second DC/DC connection,
the series circuit has a first connection and a second connection and the first connection is connected to the on-board power supply connection and the second connection is connected to a reference potential,
the current measuring arrangement is designed to provide a first measurement signal, which is representative of a current that is flowing in the series circuit, for a control unit, and
the DC/DC converter is designed to operate in a buck mode or a boost mode on the basis of a control signal that the control unit provides depending on the first measurement signal.

2. The device as claimed in claim 1, wherein the device has a voltage measuring arrangement that is designed and arranged to provide a second measurement signal, which is representative of a voltage at the on-board power supply connection, for the control unit, and the control unit additionally provides the control signal on the basis of the second measurement signal.

3. The device claimed in claim 2, wherein the voltage measuring arrangement has a voltage divider with a partial voltage tap, which is connected or is able to be connected to the control unit for providing the second measurement signal.

4. The device as claimed in claim 1, wherein the first energy storage unit has at least one electrochemical capacitor.

5. A method for operating a device claimed in claim 1, comprising:
reading in provided first measurement data that are representative of a current that is flowing in the series circuit,
ascertaining a temporal current gradient on the basis of the first measurement data,
comparing the ascertained current gradient with a predetermined gradient threshold value and, if the absolute value of the ascertained current gradient exceeds the predetermined gradient threshold value, ascertaining the control signal for the DC/DC converter on the basis of the first measurement data and/or the ascertained current gradient and providing the control signal for the DC/DC converter, wherein the control signal causes the DC/DC converter to operate in boost mode or buck mode.

6. The method as claimed in claim 5, in which the first control signal is additionally ascertained on the basis of provided second measurement data and, before the first control signal is provided, the method has the further steps of:
reading in the provided second measurement data that are representative of a voltage that is present at the on-board power supply connection, and ascertaining a voltage value on the basis of the second measurement data,
if a current is flowing from the buffer capacitor into the on-board power supply, checking whether the ascertained voltage value falls below a lower voltage limit value, and if the ascertained voltage value falls below the lower voltage limit value, providing the control signal in such a way that the control signal causes the DC/DC converter to operate in boost mode, and
if the current is flowing from the on-board power supply into the buffer capacitor, checking whether the ascertained voltage value exceeds an upper voltage limit value, and if the ascertained voltage value falls below the lower voltage limit value, providing the control signal in such a way that the control signal causes the DC/DC converter to operate in buck mode.

7. The method as claimed in claim 6, in which a current that the DC/DC converter provides at the second DC/DC connection in boost mode or buck mode is regulated on the basis of the first measurement data.

8. A control unit, comprising means for carrying out the method as claimed in claim 5.

9. An on-board power supply system for a vehicle, having:
a device as claimed in claim 1,
an on-board power supply that is connected to the on-board power supply connection of the device, and
a control unit comprising means for carrying out a method comprising:
reading in provided first measurement data that are representative of a current that is flowing in the series circuit,
ascertaining a temporal current gradient on the basis of the first measurement data, and
comparing the ascertained current gradient with a predetermined gradient threshold value and, if the absolute value of the ascertained current gradient exceeds the predetermined gradient threshold value, ascertaining the control signal for the DC/DC converter on the basis of the first measurement data and/or the ascertained current gradient and providing the control signal for the DC/DC converter, wherein the control signal causes the DC/DC converter to operate in boost mode or buck mode.

10. A computer program comprising instructions which, when the program is executed by a control computer for a device for stabilizing an on-board power supply of a vehicle, cause the latter to carry out the method as claimed in claim 5.

11. A non-transitory computer-readable medium comprising instructions which, when executed by a control computer for a device for stabilizing an on-board power supply of a vehicle, cause the latter to carry out the method as claimed in claim 5.
